(19) United States
(12) Patent Application Publication
(10) Pub. No.: US 2013/0164420 A1
(43) Pub. Date: Jun. 27, 2013

(54) Natural Sweetener And Method Of Making

(71) Applicant: MCNEIL NUTRITIONALS, LLC., Fort Washington, PA (US)

(72) Inventors: Steven J. Catani, Athens, GA (US); Steven R. Lubbe, Washington Crossing, PA (US); Joseph R. Panarisi, JR., Perrineville, NJ (US); Roma Vazirani, East Brunswick, NJ (US)

(73) Assignee: MCNEIL NUTRITIONALS, LLC., Fort Washington, PA (US)

(21) Appl. No.: 13/717,810

(22) Filed: Dec. 18, 2012

Related U.S. Application Data
(60) Provisional application No. 61/579,795, filed on Dec. 23, 2011.

(51) Int. Cl. A23L 1/236

(52) U.S. Cl. CPC A23L 1/2363
USPC 426/302; 426/658; 426/548

(57) ABSTRACT

A natural sweetening composition comprising a plant based natural high intensity sweetening compound, molasses, and a carrier/substrate.

### CROSS-REFERENCE TO RELATED APPLICATION

The present application claims the benefit of priority to U.S. Provisional Application Ser. No. 61/579,795, filed Dec. 23, 2011, the contents of which are completely incorporated by reference.

### BACKGROUND OF THE INVENTION

1. Field of the Invention

The present invention relates to sweetening compositions. More particularly, the present invention relates to a natural sweetener composition comprising a plant based natural high intensity sweetening compound (e.g., Luo Han Guo), molasses, and a carrier/substrate (a monosaccharide, a disaccharide, a sugar alcohol, and combinations thereof). Also, disclosed are methods of making such compositions.

2. Background

The market for natural foods is growing rapidly as more and more consumers are making a conscious choice to purchase food products that are natural. This trend is evident in the sweetener category, where natural sweetener products are gaining popularity. Many consumers are looking for natural sweeteners that provide the sweet taste they want with fewer calories than sugar.

High intensity sweeteners have been used by consumers for several years as a replacement for sugar. Most high intensity sweeteners have a different taste profile than sugar, where sweetness onset is slower or delayed. Some high intensity sweeteners also have bitter, metallic, astringent and/or a licorice aftertaste.

Various methods to formulate a table top sweetener using natural ingredients have been tried. Often the formulation of the product has been adjusted to try to hide or overcome the undesirable taste perceptions (e.g., bitterness) inherent in the natural sweetener product.

Flavors are typically used to solve the problem. However flavors, do not always work universally across different food or beverage forms. Flavors sometimes can be used if the product is optimized for a specific application.

Clearly, consumers want natural sweetener products. However, they have had to settle for natural sweetener products that lack the taste characteristics that they have become accustomed to. That is, the currently marketed natural sweetener products do not come close to the taste profile of sugar. Consumers complain that these products have (i) a delayed onset of sweetness, (ii) a funny aftertaste (e.g., bitterness) and/or (iii) an artificial taste. What consumers want is a natural sweetener product that more closely matches the taste profile and characteristics of sugar.

### BRIEF SUMMARY OF THE INVENTION

The present invention is directed to a natural sweetening composition comprising a plant based natural high intensity sweetening compound, molasses, and a carrier/substrate.

The present invention also is directed to a method of making a natural sweetening composition comprising the step of blending at least one plant based natural high intensity sweetening compound, molasses, and a carrier/substrate.

In one embodiment, the method of making a natural sweetening composition comprises the steps of applying a plant based high intensity sweetening compound to a carrier/substrate, thereby forming a coated substrate; and blending molasses with the coated substrate.

In another embodiment, the method of making a natural sweetening composition comprises the step of applying a coating to a carrier/substrate, thereby forming a coated substrate, wherein the coating comprises a plant based high intensity sweetening compound and molasses.

### DETAILED DESCRIPTION OF THE INVENTION

As used herein, a gram of Sucrose Equivalent Sweetness (“SES”) is understood to mean the amount of low or high intensity sweetener needed to be added to an 8 ounce glass of water in order to provide the same sweetness as an independent 8 ounce glass of water containing one gram of sucrose. For example, 1/300 g of rebaudioside A will equal about one gram of SES because rebaudioside A is about 300 times sweeter than sucrose. Similarly, about 1/50 g of glycyrrhizin will provide one gram of SES because glycyrrhizin is about 50 times sweeter than sucrose. And 1/200 g of Luo Han Guo will equal about one gram of SES because Luo Han Guo is about 200 times sweeter than sucrose.

As used herein a “high intensity sweetener” delivers 50 grams of SES or more per gram of solids.

As used herein, “plant based” is understood to mean a compound or combination of compounds naturally providing the principle sweetness in a plant.

It is the object of the invention to develop a natural sweetener with a taste profile similar to sugar.

It is another object of the invention to develop a natural sweetener that is a low calorie natural sweetener with a taste profile similar to sugar.

It is yet another object of the invention to minimize the bitter/licorice aftertaste associated with some natural sweeteners, e.g., luo han guo.

The present invention is directed to a natural sweetening composition comprising a plant based natural high intensity sweetening compound, molasses, and a carrier/substrate.

The natural sweetening composition has an improved natural flavor quality that may be perceived as a more pleasant sweet taste with reduced off-flavors from undesirable components, or reduced bitter notes.

### Plant Based

An essential component of the natural sweetening composition is a plant based natural high intensity sweetener. Plant based natural high intensity sweeteners include, but are not limited to, for example, luo han guo, stevia, agave, glycyrrhizin, serendipity berry/aka monellin/extract of Dioscorophyllum cumminsii, Brazzein—Pentadiplandra brazzeana, Thaumatin katemfe fruit (Thaumatococcus daniellii), Hernandulcin—lippia duclis, and combinations thereof.

In one embodiment, the plant based natural high intensity sweetening compound is luo han guo. Luo han guo, which is a type of melon that grows in South East Asia, is the fruit obtained from an herbaceous perennial vine, i.e., Siraitia grosvenorii. This fruit is from the Cucurbitaceae family. It is also commonly referred to as monk fruit and is about 5 to 7 cm in diameter. The exterior of the fruit is a yellow-brownish or green-brownish color, with a hard surface covered with fine hairs. Inside it contains a sweet, edible pulp and seeds. The sweet taste is derived mainly from a group of triterpene glycosides that make up approximately 1% of the flesh of the fruit, i.e., mogrosides. The mogrosides are numbered from I to V. Among them, mogrosides V and IV are known to be the sweetening components. The fruit also contains bitter components such as mogroside III and mogroside II E (unripe fruits). Cold weather prevents some fruits from maturing naturally. The unripe fruits have a bitter taste and may be included with ripe fruit during cultivation. Luo Han Guo, is roughly 200 times sweeter than sugar. It also has delayed onset sweetness and at high levels has an aftertaste.

In another embodiment, stevioside, sometimes referred to as stevia and rebaudioside A are exemplary glycosides of the diterpene derivative steviol, extracted and refined from Stevia rebaudiana bertoni (also known as eupatorium rebaudianum bertoni) leaves. These glycosides are high intensity sweeteners, about 100 to about 500 times that of sucrose, but have metallic and bitter notes. They can be used in a wide range of low or reduced calorie food products and beverages. “Stevia extract” or “extracts of Stevia” refer to a mixture of steviol glycoside extracted from a Stevia plant. Stevia extracts include, for example, such steviol glycosides as rebaudioside A, rebaudioside B, rebaudioside C, rebaudioside D, rebaudioside E, dulcoside A and dulcoside B.

The plant based natural high intensity sweetening compound is included in the natural sweetening composition in an amount from about 0.01 wt. % to about 50 wt. %, based on the total weight of the composition. Preferably, the plant based natural high intensity sweetening compound is about 0.2 wt. % to about 10 wt. %, more preferably, about 1.0 wt. % to about 2.5 wt. %, and even more preferably, about 1.2 wt. % to about 2.3 wt. %, based on the total weight of the composition.

### Molasses

Molasses is included in the natural sweetening composition to reduce the licorice/bitter aftertaste associated with the plant based natural high intensity sweetening compound, e.g., luo han guo. This is somewhat surprising as molasses also has an inherent bitter taste.

Typically, molasses is a by-product of refining cane sugar juice into sugar. Cane juice is concentrated by boiling it, which promotes crystallization of the sugar. Light, dark and blackstrap molasses are created by the first, second and third boiling step. It also has a slight bitter range to its taste. Molasses may also be included by using sweeteners which inherently include molasses. For example, non-limiting examples include raw sugar, unrefined sugar, and/or evaporated cane juice or any combination thereof.

Sorghum molasses is a natural sweetener derived from the sorghum plant by processing the juice that is extracted from the sorghum plant. It tends to have a thinner consistency and a slightly more sour taste than does molasses. Sorghum contains vitamins and minerals and is a good source of phosphorus, magnesium, thiamin and omega-6 fatty acids.

The amount of molasses used in the natural sweetening composition which reduces the unpleasant aftertaste is in the range of about 0.1 wt. % to about 25 wt. % based on the total weight of the natural sweetening composition. Preferably, the molasses is about 0.1 wt. % to about 10 wt. %, more preferably, about 0.3 wt. % to about 2.5 wt. %, and even more preferably, about 0.5 wt. % to about 2.3 wt. %, based on the weight percent of the natural sweetening composition.

Optionally, Refiner's syrup may be used in combination with molasses to enhance the sweetness profile of the plant based natural high intensity sweetener and/or to reduce the bitter/licorice aftertaste. These combinations can also be applied to other high intensity sweeteners to reduce unpleasant aftertaste such as stevia, acesulfame-K and saccharin.

Refiners Syrup or Partially Inverted Refiners Syrup, which is a pleasant tasting thick syrup with a rich unique flavor. It is a byproduct of the refining of cane sugar. The sugar cane is boiled and the sugar crystallizes. This is removed and the process repeated. Refiner's syrup is a byproduct of one stage of this process. Unlike molasses it does not have the minerals or other solids left over, just certain forms of sugar and moisture.

In one embodiment, the Molasses and Refiner's syrup are included in a ratio of about 1:1 to about 1:6, respectively.

### Carriers

Another essential feature of the inventive composition is the inclusion of a monosaccharide, a disaccharide, sugar alcohol or combinations thereof.

Monosaccharides include, for example, glucose, fructose, galactose, xylose, ribose, and combinations thereof.

Disaccharides include, for example, sucrose, lactulose, lactose, maltose, trehalose, cellobiose, kojibiose, nigerose, isomaltose, β,β-trehalose, α,β-trehalose, sophorose, laminaribiose, gentiobiose, turanose, maltulose, palatinose, gentiobiulose, mannobiose, melibiose, melibiulose, rutinose, rutinulose, xylobiose, and combinations thereof.

Sugar alcohols are food grade alcohols derived from one or more sugar molecules. Sugar alcohols include, for example, erythritol, glycol, glycerol, threitol, arabitol, xylitol, ribitol, mannitol, sorbitol, dulcitol, iditol, isomalt, maltitol, lactitol, polyglycitol and combinations thereof.

The natural sweetener composition has a ratio of carrier/substrate to plant based natural high intensity sweetening compound of from about 1:1 to about 99.9:0.1. In one embodiment, the ratio of carrier material to plant based natural high intensity sweetening compound of from about 10:1 to about 90:1. In another embodiment, the ratio of carrier material to plant based natural high intensity sweetening compound of from about 25:1 to about 50:1. In yet another embodiment, the ratio of carrier material to plant based natural high intensity sweetening compound of from about 30:1 to about 40:1.

The inventors have found that by including molasses (which has an inherent bitter taste) and a carrier/substrate (e.g., sugar and erythritol) to a plant based natural high intensity sweetener compound, results in a low calorie sweetener which had an optimum taste profile. That is, a rounded low calorie sweetener with upfront sweetness and no unpleasant aftertaste.

Additionally, a variety of ingredients may be included in the sweetening composition of the present invention.

For example, a bulking agent or other carrier material may be included. Among those disclosed or used include fructooligosaccharide (FOS) and other fibers, maltooligosaccharides, and erythritol. Erythritol is especially popular as it can mitigate some of the bitter taste. The carrier material may be in the form of a simple mixture, or co-crystallized with the high intensity sweetener.

Fruit extracts may be added to contribute additional flavor or color attributes that can elicit the perception of “natural” in the sweetener. Strawberry or blueberry flavored syrups or other berry syrup solids, as well as various concentrated fruit juices comprise a number of sweet and non-sweet compounds that contribute to the perception of “natural.”

Another optional ingredient in the composition of the present invention is a soluble food ingredient. The soluble food ingredient may be, for example, a fructooligosaccharide (FOS), a digestion resistant maltodextrin (e.g., FiberSol), erythritol, inulin, a sugar polymer, or any combination thereof. Preferably, the soluble food ingredient is a fiber.

Vitamins and minerals may also be present.

The compositions may contain other components, including flavor, aroma, other nutritional component, binders, and mixtures thereof.

The natural sweetening compositions disclosed, can be amorphous or crystalline solids, or liquids, or syrups. They can be produced by any number of processes known to those skilled in the art. In one embodiment, the composition is a powder or concentrate.

Preferably the natural sweetening compositions have less than 2.5 kcals per teaspoon (equal in sweetness to 1 tsp of sucrose), but can be formulated to deliver a wide variety of caloric contents less than the 4 kcals per gram of SES (the caloric value of sucrose). For example, the compositions can be formulated using techniques known to those working in the area, such as low bulk density spray drying, to any practical density.

The natural sweetening composition may be formulated to be a zero calorie or low calorie product. In one embodiment, the natural sweetener composition may be formulated to have less than 2 kcal per gram of SES. In another embodiment, the sweetening composition has less than 1 kcal per gram of SES. In yet another embodiment, the sweetening composition has less than 0.5 kcal per gram of SES. In still yet another embodiment, the sweetening composition has less than 0.25 kcal per gram of SES.

Additionally, the natural sweetener composition has a density of from about 0.1 g/cm³ to about 1.0 g/cm³. Preferably, from about 0.1 g/cm³ to about 0.9 g/cm³. More preferably, from about 0.5 g/cm³ to about 0.8 g/cm³.

In one embodiment, the sweetening power of the composition varies from about 0.5× to about 20× of sugar.

The natural sweetener composition has a ratio of carrier material to plant based natural high intensity sweetening compound of from about 1:1 to about 99:1. In one embodiment, the ratio of carrier material to plant based natural high intensity sweetening compound of from about 10:1 to about 90:1. In another embodiment, the ratio of carrier material to plant based natural high intensity sweetening compound of from about 25:1 to about 50:1. In yet another embodiment, the ratio of carrier material to plant based natural high intensity sweetening compound of from about 30:1 to about 40:1.

The inventive sweetening composition may be made by any suitable process. In one embodiment, the plant based natural high intensity sweetening compound, molasses, and carrier/substrate are blended in a mixer.

Some plant based natural high intensity sweetener compounds, e.g., Luo Han Guo, when blended with crystalline sugar, results in a product that has blend uniformity and segregation issues due to particle size differences between crystalline sugar and the plant based natural high intensity sweetener compound. The resulting product may be dusty and may have a different appearance than crystalline sugar. Thus, alternative processing methods may be used to produce a natural sweetening composition.

In one embodiment, a natural sweetening composition is made by applying a plant based natural high intensity sweetening compound to a carrier/substrate, thereby forming a coated substrate. The plant based natural high intensity sweetening compound may be applied in any suitable manner, so long as the plant based natural high intensity sweetening compound covers at least a portion of the surface of the carrier/substrate. For example, the plant based natural high intensity sweetening compound may be applied as a coating onto the carrier/substrate. The coated substrate is then blended with molasses. Optionally, the coated substrate is subjected to a drying step prior to the blending step.

In another embodiment, a natural sweetening composition is made by applying a coating to a carrier/substrate, thereby forming a coated substrate. The coating contains a plant based natural high intensity sweetening compound and molasses. Optionally, the coated substrate is subjected to a drying step.

An optional feature of any of the methods of manufacturing is that the plant based high intensity sweetening compound is co-crystallized with the carrier/substrate.

It is desired to have a uniform natural table-top sweetener, it is important that monk fruit extract and molasses is uniformly blended with substrate of sugar and sugar alcohol. In order to facilitate uniformity, a solution of molasses is sprayed on sugar/erythritol, and monk fruit extract is added as a dry add in between spray solutions of molasses, or a blend of luo han guo with molasses is sprayed on the core which is heated to about 70° F. to about 180° F. More preferably, the core is heated to about 70° F. to about 150° F. In one embodiment, the core is heated to about 120° F.

The natural sweetening composition may be packaged in any format known to those skilled in the art. For example, sachets, bulk bags, packets, bags, canisters, tubs, bottles, jars, drums, etc. may be used for packaging.

Unless otherwise defined, all technical and scientific terms used herein have the same meaning as commonly understood by one of ordinary skill in the art to which this invention pertains. The materials, methods, and examples described herein are illustrative only and not intended to be limiting.

The following example is provided to further illustrate the compositions and methods of the present invention. The example is illustrative only and is not intended to limit the scope of the invention in any way.

### EXAMPLES

### Example 1

| Ingredient | % (w/w) |
|---|---|
| Sugar | 48.25 |
| Erythritol | 48.25 |
| Plant based natural high intensity | 1.50 |
| sweetener compound (LHG) | |
| Molasses | 2.00 |
| TOTAL | 100.00 |

### Example 2

| Ingredient | % (w/w) |
|---|---|
| Sugar | 96.50 |
| Plant based natural high intensity | 1.50 |
| sweetener compound (LHG) | |
| Molasses | 2.00 |
| TOTAL | 100.00 |

### Example 3

| Ingredient | % (w/w) |
|---|---|
| Erythritol | 96.50 |
| Plant based natural high intensity | 1.50 |
| sweetener compound (LHG) | |
| Molasses | 2.00 |
| TOTAL | 100.00 |

### Example 4

| Ingredient | % (w/w) |
|---|---|
| Sugar | 48.25 |
| Erythritol | 48.25 |
| Plant based natural high intensity | 1.50 |
| sweetener compound (Stevia/Reb-A) | |
| Molasses | 2.00 |
| TOTAL | 100.00 |

### Example 5

| Ingredient | % (w/w) |
|---|---|
| Sugar | 96.50 |
| Plant based natural high intensity | 1.50 |
| sweetener compound (Stevia/Reb-A) | |
| Molasses | 2.00 |
| TOTAL | 100.00 |

### Example 6

| Ingredient | % (w/w) |
|---|---|
| Erythritol | 96.50 |
| Plant based natural high intensity | 1.50 |
| sweetener compound (Stevia/Reb-A) | |
| Molasses | 2.00 |
| TOTAL | 100.00 |

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A natural sweetening composition comprising:
a plant based natural high intensity sweetening compound, molasses, and
a carrier/substrate selected from the group consisting of a monosaccharide, a disaccharide, a sugar alcohol or combinations thereof.

2. The composition of claim 1, wherein the plant based natural high intensity sweetening compound is selected from the group consisting of steviol glycosides, glycyrrhizin (and related structures), mogrosides, and mixtures thereof.

3. The composition of claim 1, wherein the natural high intensity sweetener is extracted from the group consisting of Stevia rebaudiana, Glycyrrhiza glabra, Siraitia grosvenorii and mixtures thereof.

4. The composition of claim 1, wherein the monosaccharide is glucose, fructose, galactose, xylose, ribose, or mixtures thereof.

5. The composition of claim 1, wherein the disaccharide is sucrose, lactulose, lactose, maltose, trehalose, cellobiose, kojibiose, nigerose, isomaltose, β,β-trehalose, α,β-trehalose, sophorose, laminaribiose, gentiobiose, turanose, maltulose, palatinose, gentiobiulose, mannobiose, melibiose, melibiulose, rutinose, rutinulose, xylobiose, or mixtures thereof.

6. The composition of claim 1, wherein the sugar alcohol is erythritol, glycol, glycerol, threitol, arabitol, xylitol, ribitol, mannitol, sorbitol, dulcitol, iditol, isomalt, maltitol, lactitol, polyglycitol or mixtures thereof.

7. The composition of claim 1, wherein the molasses is about 0.1 wt. % to about 25 wt. %, based on the total weight of the natural sweetening composition.

8. The composition of claim 1, further comprising Refiner's syrup.

9. The composition of claim 8, wherein the ratio of molasses to Refiner's syrup is about 1:1 to about 1:6.

10. The composition of claim 1, wherein the plant based natural high intensity sweetening compound is co-crystallized with the carrier/substrate.

11. The composition of claim 1, wherein the natural sweetening composition has less than 0.25 kcal per gram of SES.

12. The composition of claim 1, wherein the natural sweetening composition has less than 0.5 kcal per gram of SES.

13. The composition of claim 1, wherein the natural sweetening composition has a density of from about 0.1 g/cm³ to about 1.0 g/cm³.

14. The composition of claim 1, wherein the natural sweetening composition has a ratio of carrier/substrate to plant based natural high intensity sweetening compound of from about 1:1 to about 99.9:0.1.

15. The composition of claim 1, wherein the natural sweetening composition has a ratio of carrier/substrate to plant based natural high intensity sweetening compound of from about 10:1 to about 90:1.

16. The composition of claim 1, wherein the natural sweetening composition has a ratio of carrier/substrate to plant based natural high intensity sweetening compound of from about 25:1 to about 50:1.

17. The composition of claim 1, wherein the natural sweetening composition has a ratio of carrier/substrate to plant based natural high intensity sweetening compound of from about 30:1 to about 40:1.

18. The composition of claim 1, wherein the composition is a powder or concentrate.

19. The composition of claim 1, wherein the resulting natural sweetening composition has a natural taste.

20. A method of making a natural sweetening composition comprising the step of:
blending at least one plant based natural high intensity sweetening compound, molasses, and a carrier/substrate.

21. The method of claim 20, wherein the carrier/substrate is selected from the group consisting of a monosaccharide, a disaccharide, a sugar alcohol, and mixtures thereof.

22. The method of claim 20, wherein the plant based natural high intensity sweetening compound is selected from the group consisting of luo han guo, steviol glycosides, glycyrrhizin (and related structures), mogrosides, and mixtures thereof.

23. The method of claim 20, wherein the natural sweetening composition further comprises Refiner's syrup.

24. A method of making a natural sweetening composition comprising the steps of:
applying a plant based high intensity sweetening compound to a carrier/substrate, thereby forming a coated substrate; and
blending molasses with the coated substrate.

25. The method of claim 24, wherein the coated substrate is subjected to a drying step prior to the blending step.

26. The method of claim 24, wherein the plant based high intensity sweetening compound is co-crystallized with the carrier/substrate.

27. The method of claim 24, wherein the carrier/substrate is selected from the group consisting of a monosaccharide, a disaccharide, a sugar alcohol, and mixtures thereof.

28. The method of claim 24, wherein the natural sweetening composition further comprises Refiner's syrup.

29. The method of claim 24, wherein the carrier/substrate is heated to a temperature of about 70° F. to about 180° F.

30. The method of claim 24, wherein the carrier/substrate is heated to a temperature of about 120° F.

31. A method of making a natural sweetening composition comprising the step of:
applying a coating to a carrier/substrate, thereby forming a coated substrate;
wherein the coating comprises a plant based high intensity sweetening compound and molasses.

32. The method of claim 31, wherein the coated substrate is subjected to a drying step.

33. The method of claim 31, wherein the plant based high intensity sweetening compound is co-crystallized with the carrier/substrate.

34. The method of claim 31, wherein the carrier/substrate is selected from the group consisting of a monosaccharide, a disaccharide, a sugar alcohol, and mixtures thereof.

35. The method of claim 31, wherein the natural sweetening composition further comprises Refiner's syrup.

36. The method of claim 31, wherein the carrier/substrate is heated to a temperature of about 70° F. to about 180° F.

37. The method of claim 31, wherein the carrier/substrate is heated to a temperature of about 120° F.
